(19) United States
(12) Patent Application Publication
(10) Pub. No.: US 2013/0066961 A1
(43) Pub. Date: Mar. 14, 2013

(54) AUTOMATED CROWDSOURCING TASK GENERATION

(71) Applicants: Vijay K. Naik, Pleasantville, NY (US); Zon-Yin Shae, South Salem, NY (US); Maja Vukovic, New York, NY (US)

(72) Inventors: Vijay K. Naik, Pleasantville, NY (US); Zon-Yin Shae, South Salem, NY (US); Maja Vukovic, New York, NY (US)

(73) Assignee: International Business Machines Corporation, Armonk, NY (US)

(21) Appl. No.: 13/228,162

(22) Filed: Sep. 8, 2011

(51) Int. Cl. G06F 15/16

(52) U.S. Cl. 709/204

(57) ABSTRACT

An embodiment of the invention automatically generates for a crowdsourcing procedure to achieve a goal. A first template pertaining to the prespecified goal is constructed, and provides a specified context and set of rules, and is associated with one or more data repositories. The first template is used to generate first level tasks, wherein a given first level task is completed by selecting a single object from a repository of objects, and then performing an operation requiring information from the single object. The first template is used further to generate second level tasks, a given second level task being completed by selecting a plurality of objects from the same or from different repositories, and then performing a single operation requiring information supplied by respective objects. The given second level task is submitted to the crowdsourcing procedure for execution.

### BACKGROUND OF THE INVENTION

1. Field of the Invention

The invention disclosed and claimed herein generally pertains to crowdsourcing, wherein software service providers are engaged online to perform specified tasks. More particularly, the invention pertains to crowdsourcing of the above type, wherein tasks are of varying complexity, and are generated automatically according to specifications provided by an entity such as the task owner or requester.

2. Description of the Related Art

As is known by those of skill in the art, Web 2.0 Technologies® have significantly enhanced interactive information sharing and collaboration over the Internet. This has enabled crowdsourcing to develop as an increasing popular approach for performing certain kinds of important tasks. In a crowdsourcing effort or procedure, a large group of organizations, individuals and other entities that desire to provide pertinent services, such as a specific community of providers or the general public, are invited to participate in a task that is presented by a task requester. Examples of such tasks include, but are not limited to, developing specified software components or the like.

At present, a crowdsourcing platform may serve as a broker or intermediary between the task requester and software providers who are interested in undertaking or participating in task performance. Crowdsourcing platforms generally allow requesters to publish or broadcast their challenges and tasks, and further allow participating providers that are successful in completing the task to receive specified monetary rewards or other incentives. Innocentive®, TopCoder®, and MechanicalTurk® are examples of presently available platforms.

Currently however, there is no system or process available for automatically creating tasks that are to be broadcast to a crowd for crowdsourcing. Instead, such tasks typically must be manually assembled. At present, scripts or API mechanisms may be used to generate multiple instances of a task that has already been manually created. However, creation of the core tasks is generally not addressed by the current state of the art. Thus, popular and successful crowdsourcing platforms require task requesters to manually enter their requirements and post their tasks.

### SUMMARY

Embodiments of the invention provide a method, system and computer program product for automatically generating tasks for crowdsourcing, wherein each task is characterized by one of multiple levels of complexity. Also, some embodiments may be adapted to mine the vast amounts of data which are presently available online, for use in generating crowdsourcing tasks. One exemplary embodiment of the invention is directed to a method for automatically generating a set of tasks for use in connection with a crowdsourcing procedure, in order to achieve a prespecified goal. The method comprises the step of constructing a first template which pertains to the prespecified goal, provides a specified context and is associated with one or more data repositories. The method further comprises using the first template to generate one or more first level tasks, wherein a given one of the first levels tasks is generated by selecting a single object of a specified type from a repository containing a plurality of objects, and then generating a specification for performing a single operation on the single object encapsulated by the task. The given first level task is submitted to the crowdsourcing procedure for execution, in order to complete the given first level task.

### BRIEF DESCRIPTION OF THE DRAWINGS

FIG. 1 is a schematic diagram showing a task generator for an embodiment of the invention.

FIG. 2 depicts a flow chart showing steps of a method for generating tasks for an embodiment of the invention.

FIG. 3 is a schematic diagram showing components for a further embodiment of the invention.

FIG. 4 is a block diagram showing a data processing system that may be used as one or more of the components of the embodiment of FIG. 1 or FIG. 3.

### DETAILED DESCRIPTION OF THE PREFERRED EMBODIMENT

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

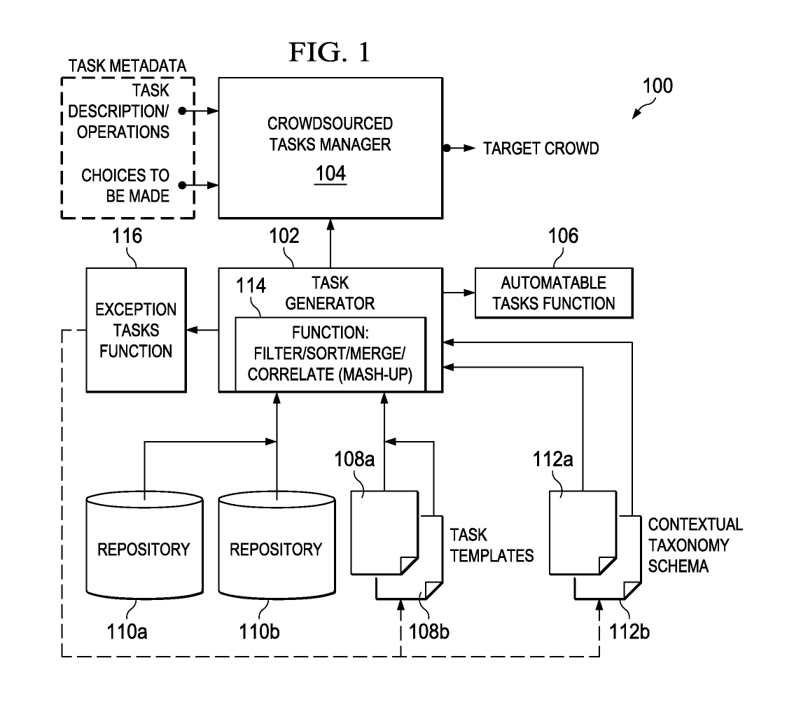

Referring to FIG. 1, there is shown Task Generator 102 for use in implementing embodiments of the invention. More particularly, Task Generator 102 is disposed to automatically create or generate tasks that can usefully be made available for execution using a crowdsourcing procedure as described above. Each generated task is one of three types or patterns, depending on its level of complexity as described hereinafter in further detail. First level tasks are the simplest, second level tasks are significantly more complex, and third level tasks are the most complex type. In a useful embodiment, Task Generator 102 is configured to distinguish between tasks of different types, and to deliver the more complex tasks for possible crowdsourcing, as illustrated by Crowdsourced Tasks Manager 104 of FIG. 1. On the other hand, simpler tasks such as many or most first level tasks may be retained and carried out automatically, such as by a local processing mechanism or the like. This is illustrated by Automatable Tasks Function 106 of FIG. 1, which may include such a mechanism. Automatable tasks are filtered out from tasks to be crowdsourced.

As an input to enable creation or generation of respective tasks, Task Generator 102 must receive a task template such as task template 108a or 108b. A task template specifies a high level description of a method with operations to perform over one or more repositories to generate a task. Users who wish to use crowdsourcing first define a template for the task and then identify one or more repositories or other data sources that contain data objects, such as repositories 110a and 110b, from which tasks are to be generated using the procedure defined in the template. A repository may consist of a static data source such as a spreadsheet, a file or a database. A repository may also be a dynamic data source such a distributed file system or even the World Wide Web which may be searched for a specific type of data using the method specified in the template. Using the method and directives in the template and the specified repositories, Task Generator 102 then repeatedly performs actions over the repositories to automatically produce or define specific tasks. The task template may further specify a set of rules and/or preconditions to be used when processing the data in the repositories. Task Generator 102 is additionally supported by a context specific taxonomy such as contextual taxonomy schema 112a and 112b. These further define the context for respective tasks which must be carried out in order to achieve the specified goal.

In embodiments of the invention, a first level task, also referred to as a pattern I type of task, is characterized as being created from well defined atomic objects which are contained in a repository. A first level task may be defined and generated by selecting a single atomic data object from the repository. Such a task may then be completed by performing a single, well defined operation on the information supplied by or contained in the selected single object. First level tasks are generally characterized further by well defined choices, explicit patterns and rules and well defined data sources, and can be readily carried out using patterns and rules.

Examples of first level tasks include transcription, classification, topic specific content generation, data collection, image tagging, feedback, usability tests, and proof reading. It will be seen that tasks of this sort may be readily generated by repeatedly applying a template a number of times, on each of multiple objects contained in a repository. Generation of first level tasks can be automated in a straightforward manner.

A second level task, also referred to as a pattern II type of task, is generated by combining two or more data objects which are taken either from the same repository or from different repositories. Thus, in order to generate a pattern II type of task, it is necessary to select two or more objects from the same or different repositories and perform a set of operations on these objects. The associated templates specify the method for selecting data objects and the operations to carry out. In some cases, a mash-up of data may be required for defining a task of this type. That is, a second level task requires an operation that selectively blends or combines information which is provided by each of the two or more objects. Examples of a mash-up or blending operation include, without limitation, filtering, sorting, merging and correlating the provided information, as shown by function 114 of Task Generator 102.

Second level tasks are further characterized as having well-defined task operations and well-defined choices. However, some parts or portions of a second level task pattern may not be explicitly defined, or may require further evaluation. Thus, further search and discovery may be required. Moreover, some parts of the task pattern may need results from certain first level tasks or from dynamic rules. In like manner with first level tasks, second level tasks can be iterated to perform the same task a number of times, on different objects contained in one or multiple repositories. The decomposition of second level tasks into subtasks, orchestration of subtasks, merging and processing of intermediate results that may further generation of additional subtasks is handled by Task Generator 102. The subtasks may be crowdsourced or processed via machine automation. The entire orchestration for each main task is performed using a workflow for that task. The task generator generates the workflow using the associated template. Some portions of the workflow may be evaluated dynamically based on the intermediate results of the subtasks. For example, the workflow may consist of branching or additional search and subtask generation based on the aggregation of results from completed subtasks.

As described above, Task Generator 102 is provided with the capability to recognize the comparative complexity of the tasks which it generates. Using the criteria specified in the templates and the rules, it recognizes the method to use for task evaluation. Tasks that meet the automation criteria are handled by routing to machine processing by invoking appropriate functions in Automatable Tasks Function 106. Tasks that meet the crowdsourcing criteria are dispatched to a crowdsourcing platform that is described in a subsequent section. The remaining tasks that do not meet either criteria are flagged as exception tasks and are sent back for further evaluation by experts of the system. In one embodiment, by way of example, the criteria could be that each task defined to be a first level task would be routed to Automatable Tasks Function 106 for automated processing, and each second level task would be routed for crowdsourcing. However, it is not intended to limit the invention thereto. In another embodiment, there could be criteria that would route some first level tasks to the crowdsourcing platform, and/or would route some second level tasks for automated processing.

When a task is routed to the crowdsourcing platform, Task Generator 102 also specifies the qualifications of the task evaluator and, when possible, choices to be provided to the task evaluator. Tasks designated for evaluation using crowdsourcing, are routed to Crowdsourced Tasks Manager 104 which interfaces with the crowdsourcing platform described subsequently. Inputs to Crowdsourced Tasks Manager 104 include a Task Description/Operations input, which sets forth respective properties of a task, and a Choices to be Made input. When a particular task is selected for crowdsourcing, Crowdsourced Tasks Manager 104 specifies a Target Crowd as an output, to which the particular task is to be directed. The Target Crowd could, for example, be the general public or a specified community of crowdsourcing providers. The Target Crowd information would usefully be sent to a crowdsourcing platform along with the particular task. When subtasks are processed as part of a larger workflow associated with a task, Crowdsourced Tasks Manager 104 also acts as an aggregator of the intermediate results from crowdsourcing and feeds those back to the task orchestrator in Task Generator 102. Note that both Task Generator 102 and Crowdsourced Tasks Manager 104 are multi-task enabled. In other words, these components are capable of simultaneous marshalling of multiple tasks generated from the same template.

First level tasks and second level tasks as described above, and their use in achieving a prespecified goal, are usefully illustrated by an example. The example pertains to an effort to transform the workload of a legacy application to a cloud computing environment for processing. A legacy application is typically an older application, such as a financial or accounting application or other product, which resides on a server at some location. There is increasing interest in transforming the workloads of such applications, so that they can be migrated to providers of cloud computing services for processing.

Legacy applications of the above type usually have a number of software and hardware components, which each have specific characteristics such as versions, releases, patch levels, and component dependencies. However, the resources available in a cloud computing environment are generally not customizable to the needs of different cloud user entities. Instead, such resources are limited to standardized offerings. As a common practice, providers of cloud computing services will have catalogues or portfolios of the cloud instances which they support.

In view of this situation in cloud computing, it is usually necessary to make modifications or adjustments to components of a legacy application, in order to fit the application to available standardized offerings in the cloud environment. For example, a specific function may have to be configured for a legacy application, in order to run the application on a standard cloud based server, rather than on the original application server. Moreover, the use of standard cloud based offerings, together with required modifications made to legacy application components, must not significantly diminish the capability to process legacy application workloads.

It will be appreciated that determining a small or acceptable number of standard cloud based offerings, which can be used to process substantially all of the application workloads, is likely to require a great deal of effort. For example, it will typically be necessary to access substantial amounts of information from databases that pertain to both application components and to the cloud based offerings, and to then analyze and compare such information and make decisions.

In order to automate the above effort, an embodiment of the invention can use a mechanism such as Task Generator 102 to generate the following set of tasks:
Task 1. Determine all the components that are candidates for migration.
Task 2. For each candidate component, determine its O/S version, servers, release, and patch level information.
Task 3. For each candidate component, determine its constraints with respect to its dependencies on other components, and their versions and releases, and supported protocols and platforms.
Task 4. For each candidate component, determine the degree to which each constraint can be relaxed to enable migration to a given standard cloud based offering, the capacity to process legacy workloads using the given offering, and associated migration cost and effort.
Task 5. Iterate over Tasks 3 and 4 until an acceptable number of standard cloud based offerings can be used to process all or a minimum number of workloads with acceptable migration costs.

Task 1 could be carried out by successively accessing each component of a legacy application from a repository, and then applying a prespecified set of rules or conditions to the accessed component, in order to determine whether or not such component is a candidate for migration for cloud computing. Accordingly, Task 1 could be a first level task, as defined above. In a useful embodiment, based on criteria specified in the template with which Task 1 is associated, it would be determined that Task 1 is to be carried out by an automation process. Task 1 would, therefore, be routed by invoking Automatable Tasks Function 106.

Task 2 seeks to determine the environment in which the existing legacy application is running. Accordingly, it determines information for candidate components such as O/S version, servers used, release and patch level information. Task 3 is provided to determine the constraints on each candidate component, with respect to dependencies on other components. Task 3 is focused more specifically on characteristics such as versions, releases, and supported protocols and platforms of these other components. It is anticipated that all the determinations required for Tasks 2 and 3 could be carried out by a series of first level tasks, each directed to accessing specific information regarding a particular one of the candidate components selected from a component repository. Moreover, it is anticipated that respective actions required for Tasks 2 and 3 could each be performed using automation. Thus, criteria specified in the template would route both Tasks 2 and 3 by invoking Automatable Tasks Function 106, in like manner with Task 1.

Task 4 pertains to determining whether the constraints determined by Task 3 can be relaxed sufficiently to allow migration to a given one of the standard cloud based offerings. Task 4 is further concerned with assessing the capacity to process legacy workloads using the given offering, and migration costs and efforts associated therewith. It is considered that Task 4 is a fairly complex second level task, as defined above. For example, Task 4 can require comparing information for each of multiple candidate components selected from one repository, with information for each of multiple given standard offerings selected from another repository.

As a second level task, Task 4 can be broken into subtasks as described above, wherein the subtasks are orchestrated by Task Generator 102. Task Generator 102 also merges and processes intermediate results, which may provide subtasks. Moreover, criteria specified by the template associated with Task 4 may route one or more of the subtasks for automated machine processing, by means of Automatable Tasks Function 106. At the same time, the criteria could direct other subtasks to a crowdsourcing platform. Orchestration of Task 4 is performed using a workflow, which is generated by Task Generator 102. Portions of this workflow can be evaluated dynamically, using intermediate results of the subtasks.

Task 5 incorporates steps of Task 4, and could thus be performed in a manner similar thereto.

As stated above, tasks of the third level are the most complex type. Third level tasks use multiple objects that are dissimilar from one another, and mash-up is required for task creation. Third level tasks involve meta-patterns, or a pattern of patterns that requires other tasks to be completed first to determine the rules for generating the pattern to be followed for getting to the solution. Examples of third level task include, without limitation, problem determination, trouble shooting types of problems, design optimization problems and template generation for first and second level tasks.

Referring further to FIG. 1, there is shown an Exception Tasks Function 116. In its operation, Task Generator 102 may conclude that some tasks must be carried out to achieve a specified goal, wherein the task does not meet criteria specified in the template, either for routing to the crowdsourcing platform, or for automated processing by Automatable Tasks Function 106. When this situation occurs, Task Generator 102 will notify Exception Tasks Function 116 of the existence of such exception task. In response, Exception Tasks Function 116 may determine that human involvement is required to deal with the exception task. Alternatively, Exception Tasks Function 116 may act to provide an additional template for Task Generator 102, which pertains to the exception task. This is indicated by the broken line path from Exception Tasks Function 116 to templates 108a-b and contextual taxonomy schema 112a-b.

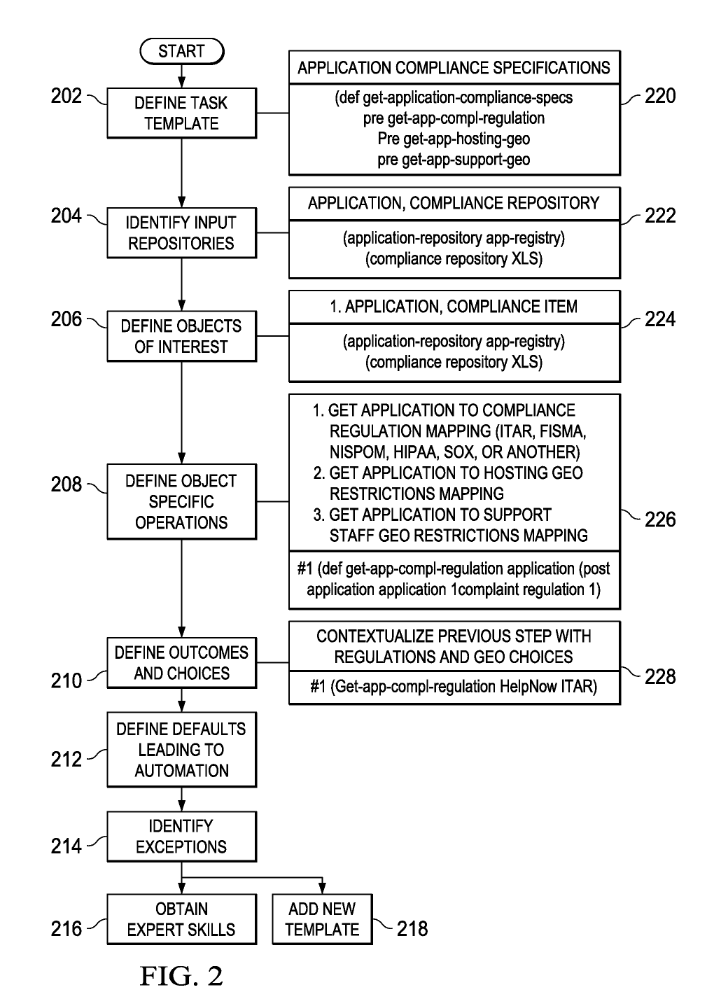

Referring to FIG. 2, there is shown a flowchart which depicts steps 202-218 of a procedure or method for building or generating a second level task of the type described above. The procedure, which is given by way of example only and by no means limits the invention, is intended to achieve a goal of verifying compliance of one or more applications with pertinent compliance specifications. Respective steps of the procedure may be carried out by a task generator such as Task Generator 102 of FIG. 1. Usefully, Task Generator 102 is provided with artificial intelligence (AI) for acquiring and making successive conclusions, in the process of constructing tasks.

Referring further to FIG. 2, there are shown information boxes 220-228 located to the right of steps 202-210. Boxes 220-228 correspond to steps 202-210 respectively, and each box 220-228 contains exemplary information that is pertinent to implementation of its corresponding step.

As described above, a task template is a required input for task generation. Accordingly, the initial step 202 in the flow chart is to define a task template, which requires specifying a goal or set of goals as stated above. Information box 220 corresponding to step 202 discloses a conjunction of goals, which include (1) verifying a level of application compliance with certain compliance specifications; (2) verifying application hosting; and (3) verifying application support. These goals are respectively indicated by notations contained in information box 220, which are in conventional AI form. Thus, information box 220 discloses that the template sets forth three atomic tasks.

Step 204 identifies each of the input repositories that contain information needed for the respective atomic tasks. Information box 222 corresponding to step 204 discloses that for the task of verifying the level of application compliance, the repositories of interest would be the application repository and the compliance repository. The application repository contains a number of different applications as objects and the compliance repository contains pertinent compliance regulations for the applications.

While not shown in information box 222 of FIG. 2, step 204 would also identify the input repositories for the atomic tasks of verifying application hosting and verifying application support. For example, for the step of verifying application hosting, step 204 could identify a repository that contained a list of application servers.

Step 206 defines objects of interest. For the task of verifying the level of application compliance, information box 224 indicates that objects of interest would include a specific application selected from the application repository, and a specific compliance item selected from the compliance repository.

Step 208 defines object specific operations that are to be performed on the objects of step 206. As an exemplary operation shown by information box 226, each application of step 206 could be mapped to certain specified compliance regulations. Results of the mapping operations could also be provided.

Step 210 requires defining outcomes and choices. As an example indicated by information box 228, it is recognized that pertinent compliance regulations could be different for different countries or other geographic entities. Accordingly, step 208 would be contextualized with specific geographic information.

In constructing a task in accordance with the procedure of steps 202-210, it is useful to think of the task as starting initially as an empty pattern. Data is then fed into the pattern from different repositories, in order to customize it, during successive steps of the procedure.

At step 212, Task Generator 102 of FIG. 1 may define defaults leading to automation. For example, it may be recognized that a template used in building a previous task could be reused for a new task which has the same structure. For the new task, the previously used template would be contextualized with different data than used previously.

Step 214 is provided to identify exceptions. As an example, an exception could occur if it is recognized that a new task is required for which there is no previously generated template. In this event the procedure would go to step 218, to add a new template. A further exception could occur if it was recognized that human involvement was needed in the task construction process, as referred to above. The process would then go to step 216 to obtain expert skills.

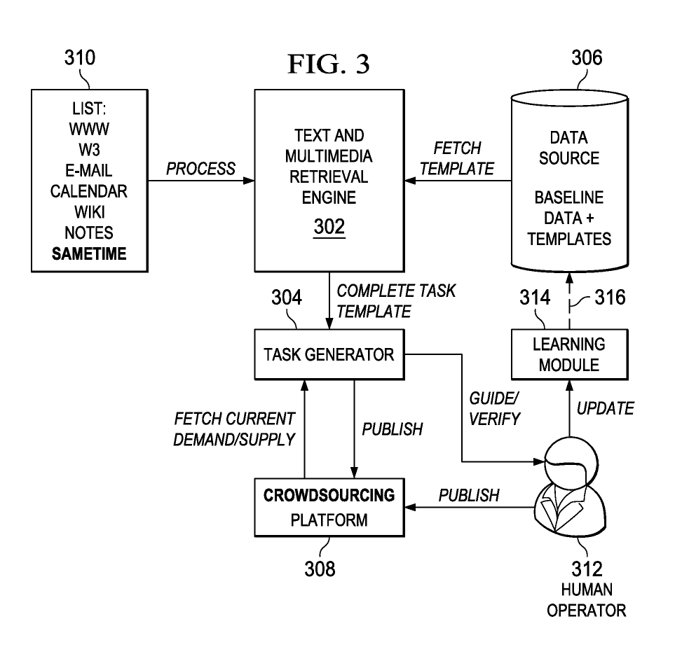

Referring to FIG. 3, there is shown text and multimedia retrieval engine 302 which is provided to retrieve information in both textual and multi-media forms, from a number of different sources. Engine 302 is configured to supply outputs to Task Generator 304, which may be similar or identical to Task Generator 102 of FIG. 1 described above, and to receive inputs from data source 306. More particularly, data source 306 provides templates and base line data to engine 302 that is related to a specified goal or set of goals. Engine 302 furnishes these templates and data to Task Generator 304, for use in building a set of tasks in order to achieve the specified goals, as described above.

FIG. 3 further shows that at least some of the tasks of the set, such as the more complex tasks as described above, are sent or published to crowdsourcing platform 308. Certain interactions then take place between crowdsourcing platform 308 and a system that operates Task Generator 304, which may pertain to supply and demand and other conditions. Following these interactions, crowdsourcing platform 308 may distribute received tasks to a specified crowd for crowdsourcing.

As an important feature, the embodiment of the invention disclosed by FIG. 3 provides engine 302 with the capability to mine and retrieve vast amounts of data which are available online. FIG. 3 shows list 310 of certain well known online data sources, including the world wide web (WWW), e-mail, and other sources. Thus, engine 302 could retrieve data by crawling the Web, from the intranets of certain enterprises, or from certain personal user data if permission is given. Such data could then be processed for use in building or assembling tasks, including crowd-executable tasks.

It is to be emphasized that the sources set forth in list 310 are provided as examples only, and are not intended to limit the scope of the invention in any way.

It is anticipated that a system such as the embodiment of FIG. 3 could be used to provide tasks of significant business value. As an example, discovery of Reusable IDs for a certain commercial purpose is an activity that can have high business value. In the past, this activity has been carried out manually, using spreadsheets to collect data about the current work groups/pools at global delivery centers, including roles available, customers supported and teams managed. Also, it would be useful to acquire further information, such as the number of servers that a particular pool is supporting, and whether a specific customer has strict guidelines in terms of support recruitment. By mining data sources of the type shown in list 310, such as certain Internet conversations, e-mail threads and project Wikis, Task Generator 304 can be operated to produce a set of tasks for automating the above activities. Some of these tasks may be distributed to a specified crowd for crowdsourcing.

Referring further to FIG. 3, there is shown a human operator 312, such as an administrator of the system of FIG. 3, who is positioned to interact with certain components of such system. For example, human operator 312 may guide or verify decisions of Task Generator 304 in regard to certain tasks. Human operator 312 may also publish tasks to crowdsourcing platform 308, and provide updates to learning module 314. Link 316 is provided from learning module 314 to data source 306, so that updates to module 314 can be used to enhance or improve templates furnished by data source 306.

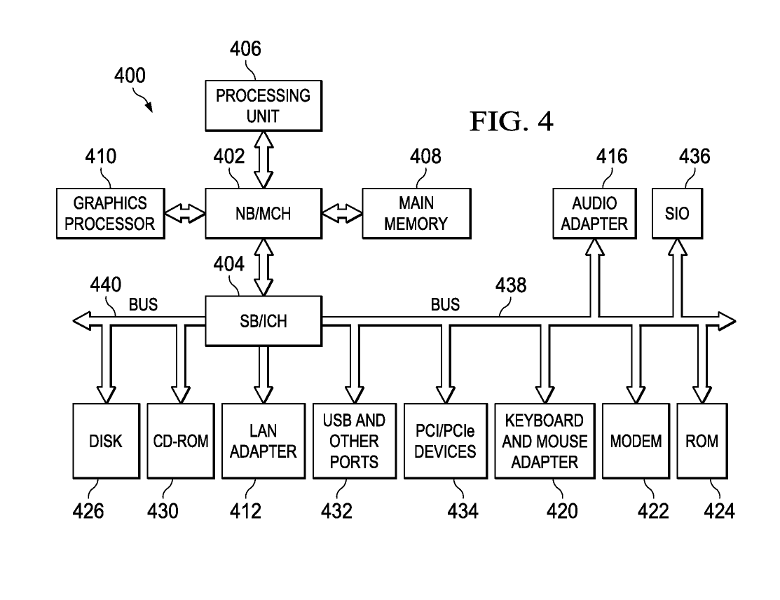

Referring to FIG. 4, a block diagram of a computer or data processing system is shown in which aspects of the present invention may be implemented. This system is an example of a computer which may be used to implement components of either FIG. 1 or FIG. 3, such as Task Generator 102 or 304, and in which computer usable code or instructions implementing the processes for embodiments of the present invention may be located.

In the depicted example, the data processing system of FIG. 4 employs a hub architecture including north bridge and memory controller hub (NB/MCH) 402 and south bridge and input/output (I/O) controller hub (SB/ICH) 404. Processing unit 406, main memory 408, and graphics processor 410 are connected to NB/MCH 402. Graphics processor 410 may be connected to NB/MCH 402 through an accelerated graphics port (AGP).

In the depicted example, local area network (LAN) adapter 412 connects to SB/ICH 404. Audio adapter 416, keyboard and mouse adapter 420, modem 422, read only memory (ROM) 424, disk 426, CD-ROM 430, universal serial bus (USB) ports and other communication ports 432, and PCI/PCIe devices 434 connect to SB/ICH 404 through bus 438 and bus 440. PCI/PCIe devices 434 may include, for example, Ethernet adapters, add-in cards, and PC cards for notebook computers. PCI uses a card bus controller, while PCIe does not. ROM 424 may be, for example, a flash binary input/output system (BIOS).

Disk 426 and CD-ROM 430 connect to SB/ICH 404 through bus 440. Disk 426 and CD-ROM 430 may use, for example, an integrated drive electronics (IDE) or serial advanced technology attachment (SATA) interface. Super I/O (SIO) device 436 may be connected to SB/ICH 404.

An operating system runs on processing unit 406 and coordinates and provides control of various components within the data processing system of FIG. 4. As a client, the operating system may be a commercially available operating system such as Microsoft® Windows® (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on the data processing system (Java is a trademark of Sun Microsystems, Inc. in the United States, other countries, or both).

As a server, the data processing system of FIG. 4 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). The data processing system may be a symmetric multiprocessor (SMP) system including a plurality of processors in processing unit 406. Alternatively, a single processor system may be employed.

Instructions for the operating system, the object-oriented programming system, and applications or programs are located on storage devices, such as disk 426, and may be loaded into main memory 408 for execution by processing unit 406. The processes for embodiments of the present invention are performed by processing unit 406 using computer usable program code, which may be located in a memory such as, for example, main memory 408, ROM 424, or in one or more peripheral devices, such as, for example, disk 426 and CD-ROM 430.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for automatically generating a set of tasks for use in connection with a crowdsourcing procedure to achieve a prespecified goal, said method comprising the steps of:
constructing a first template which pertains to said prespecified goal, provides a specified context and is associated with one or more data repositories;
using the first template to generate one or more first level tasks, wherein a given one of said first level tasks is generated by selecting a single object of a specified type from a repository containing a plurality of objects, and then generating a specification for performing a single operation on the single object encapsulated by the task; and
submitting said given first level task to the crowdsourcing procedure to complete said given first level task.

2. The method of claim 1, wherein:
said method includes using the first template to generate one or more second level tasks, wherein a given one of said second level tasks is completed by generating one or more first level tasks from one or more objects from the same repository or from different repositories, selectively, and then using crowdsourcing for first completing first level tasks and then completing composite second level tasks.

3. The method of claim 2, wherein:
said method includes generating a third level task, wherein completion of said third level task requires prior completion of at least one of said first level tasks or said second level tasks, in order to determine specified rules to be used for generating said third level task.

4. The method of claim 1, wherein:
said method includes determining that one or more of said first level tasks can be executed automatically at a specified location, and will not be submitted to the crowdsourcing procedure for execution.

5. The method of claim 1, wherein:
each of a plurality of said first level tasks are executed by performing a specified operation iteratively, on each of a plurality of different objects contained in a specified repository.

6. The method of claim 2, wherein:
responsive to determining that an additional task which is not one of said first or second level tasks is needed to achieve the prespecified goal, providing a second template for use in generating said additional task.

7. The method of claim 2, wherein:
one or more data sources in a group of online data sources are respectively mined, to acquire data for use in generating at least one of said first level tasks or second level tasks.

8. The method of claim 7, wherein:
said group of online data sources includes at least the world wide web, an enterprise intranet, and a source of user personal data.

9. The method of claim 1, wherein:
the first template is one of a plurality of templates that is required to generate all of the tasks which must be executed to achieve the prespecified goal.

10. The method of claim 1, wherein:
said method includes identifying a specified group of crowdsourcing providers to be used for the crowdsourcing procedure.

11. The method of claim 1, wherein:
said step of submitting said given task comprises submitting said given task to a selected crowdsourcing platform.

12. A computer program product executable in a computer recordable storage medium, for automatically generating a set of tasks for use in connection with a crowdsourcing procedure to achieve a prespecified goal, said computer program product comprising:
instructions for constructing a first template which pertains to said prespecified goal, provides a specified context and is associated with one or more data repositories;
instructions for using the first template to generate one or more first level tasks, wherein a given one of said first level tasks is generated by selecting a single object of a specified type from a repository containing a plurality of objects, and then generating a specification for performing a single operation on the single object encapsulated by the task;
instructions for using the first template to generate one or more second level tasks, wherein a given one of said second level tasks is completed by generating one or more first level tasks from one or more objects from the same repository or from different repositories, selectively, and then using crowdsourcing for first completing one or more first level tasks, and then completing composite second level tasks; and
instructions for submitting first and second level tasks to the crowdsourcing procedure for execution.

13. The computer program product of claim 12, wherein:
one or more data sources in a group of online data sources are respectively mined to acquire data for use in generating at least one of said first level tasks or second level tasks.

14. The computer program product of claim 13, wherein:
said group of online data sources includes at least the world wide web, an enterprise intranet and a source of user personal data.

15. The computer program product of claim 12, wherein:
said product includes identifying a specified group of crowdsourcing providers to be used for the crowdsourcing procedure.

16. The computer program product of claim 12, wherein:
submitting said tasks comprises submitting said tasks to a selected crowdsourcing platform.

17. Apparatus for automatically generating a set of tasks for use in connection with a crowdsourcing procedure to achieve a prespecified goal, said apparatus comprising:
processing means for constructing a first template which pertains to said prespecified goal, provides a specified context and is associated with one or more data repositories;
processing means for using the first template to generate one or more first level tasks, wherein a given one of said first level tasks is generated by selecting a single object of a specified type from a repository containing a plurality of objects, and then generating a specification for performing a single operation on the single object encapsulated by the task;
processing means for using the first template to generate one or more second level tasks, wherein a given one of said second level tasks is completed by generating one or more first level tasks from one or more objects from the same repository or from different repositories, selectively, and then using crowdsourcing for first completing first level tasks, and then completing composite second level tasks; and
processing means for submitting first and second level tasks to the crowdsourcing procedure for execution.

18. The apparatus of claim 17, wherein:
said apparatus determines that one or more of said first level tasks can be executed automatically at a specified location and will not be submitted to the crowdsourcing procedure for execution.

19. The apparatus of claim 17, wherein:
each of a plurality of said first level tasks are executed by performing a specified operation iteratively, on each of a plurality of different objects contained in a specified repository.

20. The apparatus of claim 17, wherein:
said apparatus includes identifying a specified group of crowdsourcing providers to be used for the crowdsourcing procedure.
